(19) United States
(12) Patent Application Publication
(10) Pub. No.: US 2018/0132248 A1
(43) Pub. Date: May 10, 2018

(54) Methods And Apparatus Of Interference Management In NR

(71) Applicant: MediaTek Inc., Hsinchu City (TW)

(72) Inventors: Weidong Yang, San Diego, CA (US); Bo-Si Chen, Keelung City (TW)

(21) Appl. No.: 15/801,282

(22) Filed: Nov. 1, 2017

Related U.S. Application Data
(63) Continuation-in-part of application No. 15/698,594, filed on Sep. 7, 2017.
(60) Provisional application No. 62/418,073, filed on Nov. 4, 2016.

(51) Int. Cl. H04W 72/08; H04W 52/24; H04W 72/04; H04L 1/18

(52) U.S. Cl. CPC H04W 72/082; H04W 52/241; H04W 24/02; H04L 1/1812; H04W 72/0406

(57) ABSTRACT

Concepts and examples pertaining to interference management in mobile communication networks and systems are described. A first node of a mobile communication network of a plurality of nodes receives a transmission grant from a second node of the mobile communication network. The first node then senses a condition of a communication channel. The first node further performs a number of operations based on a result of the sensing and a set of transmission parameters in the transmission grant. The number of operations includes determining whether or not to transmit a signal as well as adjusting transmission power of the first node.

### CROSS REFERENCE TO RELATED PATENT APPLICATION(S)

The present disclosure claims the priority benefit of U.S. Provisional Patent Application No. 62/418,073, filed 4 Nov. 2016, and the present disclosure is part of a continuation-in-part (CIP) application of U.S. Non-Provisional patent application Ser. No. 15/698,594, filed 7 Sep. 2017, which claims the priority benefit of U.S. Provisional Patent Application No. 62/384,210, filed 7 Sep. 2016. Contents of aforementioned applications are incorporated by reference in their entirety.

### TECHNICAL FIELD

The present disclosure is generally related to mobile communications and, more particularly, to interference management in mobile communication networks and systems.

### BACKGROUND

Unless otherwise indicated herein, approaches described in this section are not prior art to the claims listed below and are not admitted as prior art by inclusion in this section.

In a 5th Generation (5G) New Radio (NR) mobile communication system, the use cases of enhanced mobile broadband (eMBB) and ultra-reliable, low-latency communications (URLLC) are driving the NR design towards small schedulable units in the time domain. Under eMBB, latency and high throughput (to avoid intermediate buffering) are two drivers for small schedulable units. Small schedulable units lead to higher requirements on inter-cell/inter-link coordination, such as from a base station (BS) to a user equipment (UE), from a UE to another UE, and from a UE to a BS. Toward those ends, the design goals include the capabilities of traffic adaptation and forward compatibility as well as flexible duplex. There are two aspects with respect to traffic adaptation and forward compatibility, namely time division duplex (TDD) and frequency division duplex (FDD). For TDD (including conventional TDD spectrum and millimeter wave (mmWave) spectrum), the design goal includes downlink (DL) and uplink (UL) in TDD spectrum with dynamic use of resources for DL and UL. For FDD, the design goal includes DL/UL in DL spectrum of FDD with dynamic use of resources for DL and UL (for traffic adaptation), and the design goal also includes DL/UL in UL spectrum of FDD with dynamic use of resources for DL and UL. With respect to flexible duplex, flexible duplex is identified as a possible way to utilize conventional TDD/FDD spectrum with a unified air interface.

As transmission direction in a cell can be adjusted on a slot-by-slot basis, the so-called “dynamic TDD” is enabled. When different cells decide to use slots for DL or UL depending on the local needs, e.g., adaptation to uplink/downlink traffic, at a given slot different cells may not have aligned transmission direction. Consequently, a UE and/or an eNB/gNB/TRP can suffer from cross-link interference.

Dynamic TDD includes full duplex and quasi-full duplex. In a full duplex scenario, two nodes can transmit signals to each other and receive signals from each other at the same time. In a quasi-full duplex scenario, a BS can transmit signals to one UE and at the same time receive signals from another UE. Quasi-full duplex tends to be easier than full duplex to implement if dynamic TDD and advanced receiver technology are used. However, there are some challenges in dynamic TDD. For instance, eNB-eNB interference is identified as a severe problem in dynamic TDD. Moreover, UE-UE interference is also identified as an issue in dynamic TDD. Exchange of scheduling information among nodes due to non-ideal backhaul and critical timing arising from small schedulable units in 5G is another challenge.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose schemes, concepts, techniques, methods and apparatus for interference management in mobile communication networks and systems, e.g., in NR networks.

In one aspect, a method may involve a first node of a mobile communication network of a plurality of nodes receiving a transmission grant from a second node of the mobile communication network. The method may also involve the first node sensing a condition of a communication channel. The method may further involve the first node performing a number of operations based on a result of the sensing and a set of transmission parameters in the transmission grant. The number of operations may include determining whether or not to transmit a signal as well as adjusting transmission power of the first node.

In one aspect, a method may involve a first node of a mobile communication network of a plurality of nodes receiving a transmission grant from a second node of the mobile communication network. The method may also involve the first node sensing a condition of a communication channel. The method may further involve the first node performing a number of operations based on a result of the sensing and a set of transmission parameters in the transmission grant. The number of operations may include selecting a modulation and coding scheme (MCS) level from a plurality of MCS levels.

In one aspect, an apparatus may include a transceiver capable of wirelessly communicating with a plurality of nodes of a mobile communication network. The apparatus may also include a processor communicatively operably coupled to the transceiver. The processor may be capable of receiving, via the transceiver, a transmission grant from a base station (BS) of the mobile communication network. The processor may be also capable of sensing, via the transceiver, a condition of a communication channel. The processor may be further capable of performing a number of operations based on a result of the sensing and a set of transmission parameters in the transmission grant. The number of operations may include determining whether or not to transmit a signal as well as adjusting transmission power of the transceiver.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR) and Internet-of-Things (IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example mobile communication environment in which examples in accordance with the present disclosure may be implemented.

FIG. 2 is a diagram of an example system in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

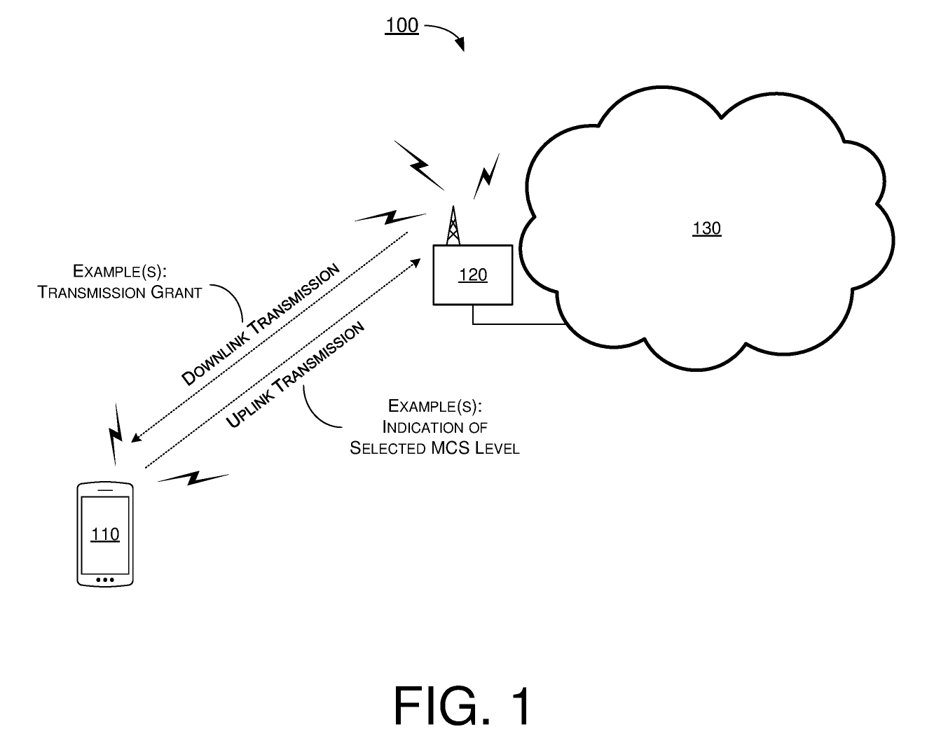

FIG. 1 illustrates an example mobile communication environment 100 in which examples in accordance with the present disclosure may be implemented. Referring to FIG. 1, mobile communication environment 100 may involve at least one user equipment, UE 110, and a base station, BS 120, of a network 130. In accordance with the present disclosure, a listen-before-talk (LBT) scheme is proposed and may be utilized. The LBT scheme may enable coordination of transmissions from different nodes of a network in a distributed way, and the different nodes may include base stations (including BS 120) and/or UEs (including UE 110). In the context of network 130 being a NR network, channel sensing may be enhanced so that a potential transmitting entity (e.g., UE 110) may make a more nuanced decision in transmission. That is, the decision is not merely related to whether or not to transmit but may also include decision on power control and link adaptation with the freshest or latest observation on the channel, which may be determined by the transmitting entity autonomously.

Under one approach of the proposed scheme, BS 120 may provide a transmission grant to UE 110, with the transmission grant including all transmission parameters. The transmission parameters may include, for example and without limitation, resource allocation, modulation and coding scheme (MCS), and hybrid automatic repeat request (HARQ) process identifier (HARQ-ID). Semi-persistent scheduling may be utilized in the communications between the BS 120 and UE 110. Through channel sensing, UE 110 may decide or otherwise determine whether to transmit or not, and may make adjustment on power control according to a result of the channel sensing.

Under another approach of the proposed scheme, BS 120 may provide a transmission grant to UE 110, with the transmission grant including some transmission parameters. Such transmission parameters may include, for example and without limitation, resource allocation and HARQ-ID. Semi-persistent scheduling may be utilized in the communications between BS 120 and UE 110. Through channel sensing, UE 110 may decide or otherwise determine whether to transmit or not, and may make adjustment to its transmit power. UE 110 may also autonomously decide or otherwise choose a MCS level from a number of possible MCS levels for its transmission. As the BS does not know the MCS level chosen or otherwise selected by UE 110, UE 110 may indicate the selected MCS level in an uplink transmission to BS 120.

### Illustrative Implementations

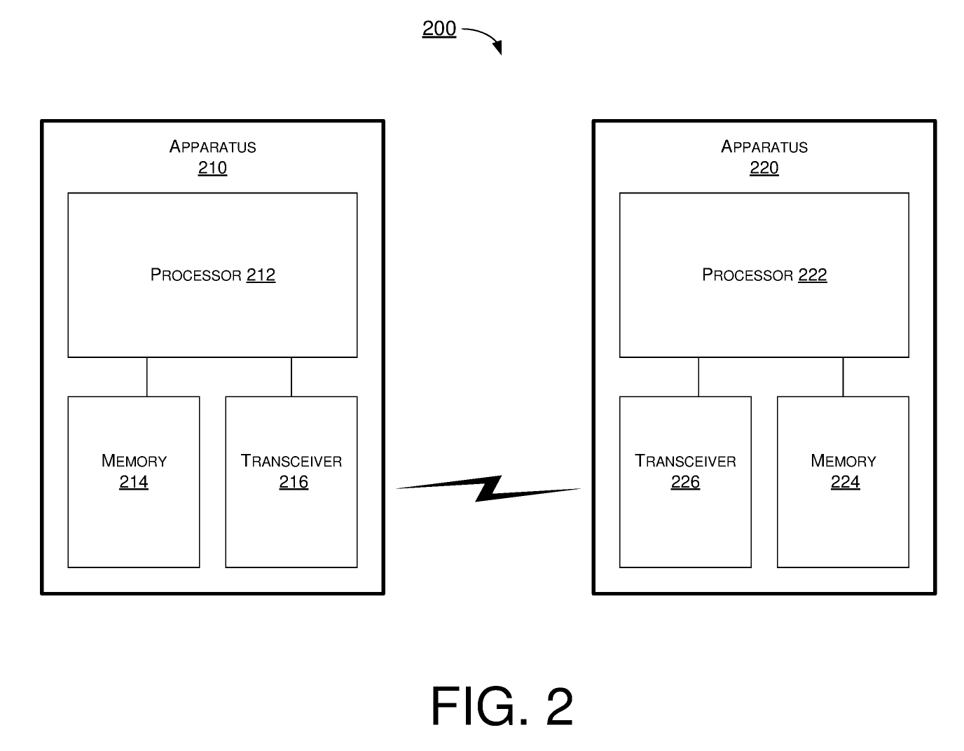

FIG. 2 illustrates an example system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to interference management in mobile communication networks and systems, including the various schemes with respect to FIG. 1 described above as well as processes 300 and 400 described below.

Each of apparatus 210 and apparatus 220 may be a part of an electronic apparatus, which may be a BS or a UE, such as a portable or mobile apparatus, a wearable apparatus, a mobile communication apparatus or a computing apparatus. For instance, each of apparatus 210 and apparatus 220 may be implemented in a smartphone, a smartwatch, a personal digital assistant, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. When implemented in or as a BS, apparatus 210 and/or apparatus 220 may be implemented in an eNodeB in a LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, or one or more complex-instruction-set-computing (CISC) processors. In the various schemes described herein, each of apparatus 210 and apparatus 220 may be implemented in or as a BS or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to interference management in mobile communication networks and systems in accordance with various implementations of the present disclosure.

In some implementations, apparatus 210 may also include a transceiver 216 coupled to processor 212. Transceiver 216 may be capable of wirelessly transmitting and receiving data. In some implementations, apparatus 220 may also include a transceiver 226 coupled to processor 222. Transceiver 226 may include a transceiver capable of wirelessly transmitting and receiving data.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

In the interest of brevity and to avoid redundancy, detailed description of the capabilities of apparatus 210 and apparatus 220 is provided below with respect to processes 300 and 400.

### Illustrative Processes

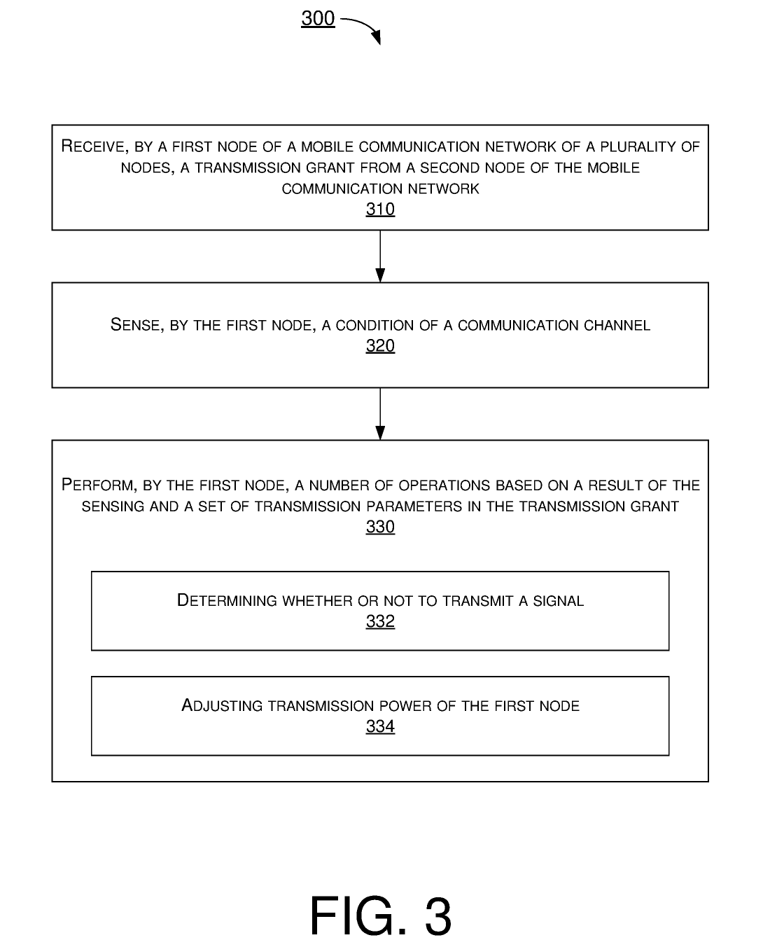

FIG. 3 illustrates an example process 300 in accordance with an implementation of the present disclosure. Process 300 may represent an aspect of implementing the proposed concepts and schemes such as one or more of the various schemes described above with respect to FIG. 1 and FIG. 2. More specifically, process 300 may represent an aspect of the proposed concepts and schemes pertaining to interference management in mobile communication networks and systems. For instance, process 300 may be an example implementation, whether partially or completely, of the proposed schemes described above for interference management in mobile communication networks and systems. Process 300 may include one or more operations, actions, or functions as illustrated by one or more of blocks 310, 320 and 330 as well as sub-blocks 332 and 334. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. The blocks/sub-blocks of process 300 may be executed iteratively. Process 300 may be implemented by or in apparatus 210 and/or apparatus 220 as well as any variations thereof. Solely for illustrative purposes and without limiting the scope, process 300 is described below in the context of apparatus 210 being a UE and apparatus 220 being a BS. Process 300 may begin at block 310.

At 310, process 300 may involve processor 212 of apparatus 210, as a first node (e.g., UE) of a mobile communication network, receiving, via transceiver 216, a transmission grant from apparatus 220, as a second node (e.g., BS) of the mobile communication network. Process 300 may proceed from 310 to 320.

At 320, process 300 may involve processor 212 sensing, via transceiver 216, a condition of a communication channel (e.g., one or more mobile communication channels through which apparatus 210 may communicate with apparatus 220). Process 300 may proceed from 320 to 330.

At 330, process 300 may involve processor 212 performing, by the first node, a number of operations based on a result of the sensing and a set of transmission parameters in the transmission grant. The number of operations may be represented by sub-blocks 332 and 334.

At 332, process 300 may involve processor 212 determining whether or not to transmit a signal (e.g., to apparatus 220).

At 334, process 300 may involve processor 212 adjusting transmission power of transceiver 216 of apparatus 210.

In some implementations, the set of transmission parameters in the transmission grant may include parameters pertaining to resource allocation, MCS, and HARQ-ID.

In some implementations, semi-persistent scheduling may be utilized in communications between apparatus 210 and apparatus 220.

In some implementations, the mobile communication network may include an NR network.

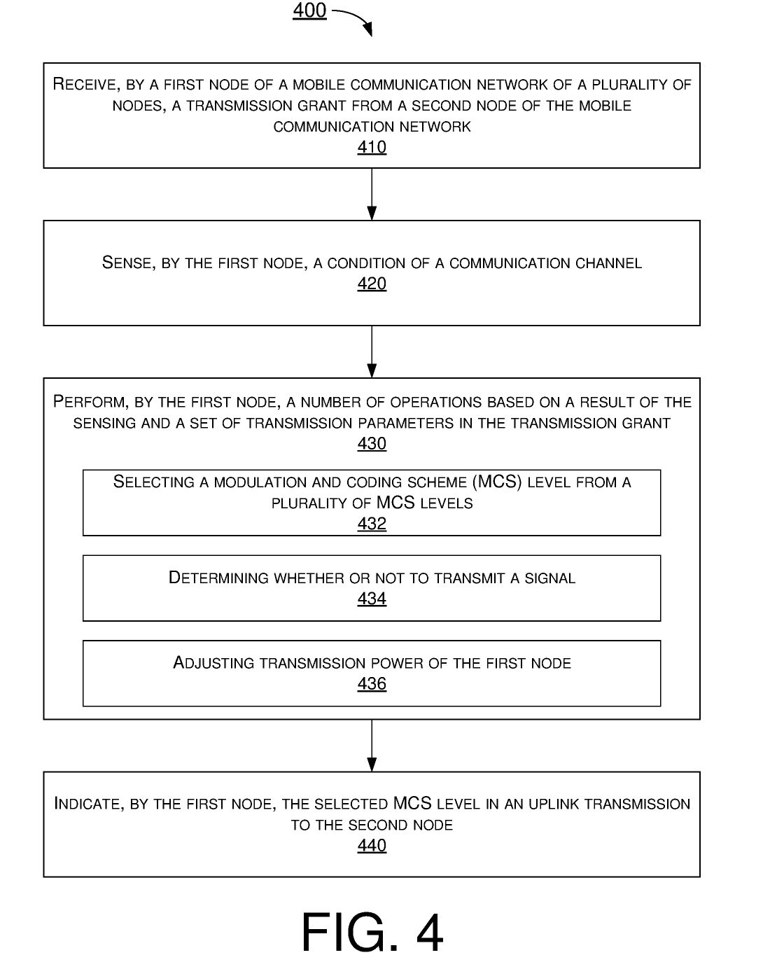

FIG. 4 illustrates an example process 400 in accordance with an implementation of the present disclosure. Process 400 may represent an aspect of implementing the proposed concepts and schemes such as one or more of the various schemes described above with respect to FIG. 1 and FIG. 2. More specifically, process 400 may represent an aspect of the proposed concepts and schemes pertaining to interference management in mobile communication networks and systems. For instance, process 400 may be an example implementation, whether partially or completely, of the proposed schemes described above for interference management in mobile communication networks and systems. Process 400 may include one or more operations, actions, or functions as illustrated by one or more of blocks 410, 420, 430 and 440 as well as sub-blocks 432, 434 and 436. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. The blocks/sub-blocks of process 400 may be executed iteratively. Process 400 may be implemented by or in apparatus 210 and/or apparatus 220 as well as any variations thereof. Solely for illustrative purposes and without limiting the scope, process 400 is described below in the context of apparatus 210 being a UE and apparatus 220 being a BS. Process 400 may begin at block 410.

At 410, process 400 may involve processor 212 of apparatus 210, as a first node (e.g., UE) of a mobile communication network, receiving, via transceiver 216, a transmission grant from apparatus 220, as a second node (e.g., BS) of the mobile communication network. Process 400 may proceed from 410 to 420.

At 420, process 400 may involve processor 212 sensing, via transceiver 216, a condition of a communication channel (e.g., one or more mobile communication channels through which apparatus 210 may communicate with apparatus 220). Process 400 may proceed from 420 to 430.

At 430, process 400 may involve processor 212 performing, by the first node, a number of operations based on a result of the sensing and a set of transmission parameters in the transmission grant. The number of operations may be represented by sub-blocks 432, 434 and 436. Process 400 may proceed from 430 to 440.

At 440, process 400 may involve processor 212 indicating, via transceiver 216, the selected MCS level in an uplink transmission to apparatus 220.

At 432, process 400 may involve processor 212 selecting a MCS level from a plurality of possible MCS levels with which transceiver 216 may transmit a signal to transceiver 226 of apparatus 220.

At 434, process 400 may involve processor 212 determining whether or not to transmit a signal (e.g., to apparatus 220).

At 436, process 400 may involve processor 212 adjusting transmission power of transceiver 216 of apparatus 210.

In some implementations, the set of transmission parameters in the transmission grant may include parameters pertaining to resource allocation and HARQ-ID.

In some implementations, semi-persistent scheduling may be utilized in communications between apparatus 210 and apparatus 220.

In some implementations, the mobile communication network may include an NR network.

In some implementations, in selecting the MCS level from the plurality of MCS levels, process 400 may involve processor 212 selecting the MCS level autonomously without consulting or obtaining permission from apparatus 220.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a first node of a mobile communication network of a plurality of nodes, a transmission grant from a second node of the mobile communication network;
sensing, by the first node, a condition of a communication channel; and
performing, by the first node, a number of operations based on a result of the sensing and a set of transmission parameters in the transmission grant, the number of operations comprising:
determining whether or not to transmit a signal; and
adjusting transmission power of the first node.

2. The method of claim 1, wherein the set of transmission parameters in the transmission grant comprises parameters pertaining to resource allocation, modulation and coding scheme (MCS), and hybrid automatic repeat request (HARQ) process identifier (HARQ-ID).

3. The method of claim 1, wherein semi-persistent scheduling is utilized in communications between the first node and the second node.

4. The method of claim 1, wherein the first node comprises a user equipment (UE), and wherein the second node comprises a base station (BS).

5. The method of claim 1, wherein the mobile communication network comprises a New Radio (NR) network.

6. A method, comprising:
receiving, by a first node of a mobile communication network of a plurality of nodes, a transmission grant from a second node of the mobile communication network;
sensing, by the first node, a condition of a communication channel; and
performing, by the first node, a number of operations based on a result of the sensing and a set of transmission parameters in the transmission grant, the number of operations comprising selecting a modulation and coding scheme (MCS) level from a plurality of MCS levels.

7. The method of claim 6, wherein the set of transmission parameters in the transmission grant comprises parameters pertaining to resource allocation and hybrid automatic repeat request (HARQ) process identifier (HARQ-ID).

8. The method of claim 6, wherein semi-persistent scheduling is utilized in communications between the first node and the second node.

9. The method of claim 6, wherein the first node comprises a user equipment (UE), and wherein the second node comprises a base station (BS).

10. The method of claim 6, wherein the mobile communication network comprises a New Radio (NR) network.

11. The method of claim 6, wherein the selecting the MCS level from the plurality of MCS levels comprises selecting the MCS level autonomously without consulting or obtaining permission from the second node.

12. The method of claim 6, wherein the number of operations further comprises:
determining whether or not to transmit a signal; and
adjusting transmission power of the first node.

13. The method of claim 6, further comprising:
indicating, by the first node, the selected MCS level in an uplink transmission to the second node.

14. An apparatus, comprising:
a transceiver capable of wirelessly communicating with a plurality of nodes of a mobile communication network; and
a processor communicatively operably coupled to the transceiver, the processor capable of:
receiving, via the transceiver, a transmission grant from a base station (BS) of the mobile communication network;
sensing, via the transceiver, a condition of a communication channel; and
performing a number of operations based on a result of the sensing and a set of transmission parameters in the transmission grant, the number of operations comprising:
determining whether or not to transmit a signal; and
adjusting transmission power of the transceiver.

15. The apparatus of claim 14, wherein the set of transmission parameters in the transmission grant comprises parameters pertaining to resource allocation and hybrid automatic repeat request (HARQ) process identifier (HARQ-ID).

16. The apparatus of claim 14, wherein semi-persistent scheduling is utilized in communications between the apparatus and the BS.

17. The apparatus of claim 14, wherein the number of operations further comprises:
selecting a modulation and coding scheme (MCS) level from a plurality of MCS levels.

18. The apparatus of claim 17, wherein the selecting of the MCS level from the plurality of MCS levels comprises selecting the MCS level autonomously without consulting or obtaining permission from the second node.

19. The apparatus of claim 17, wherein the processor is further capable of indicating the selected MCS level in an uplink transmission to the BS.

20. The apparatus of claim 14, wherein the mobile communication network comprises a New Radio (NR) network.
